(19) United States
(12) Patent Application Publication
(10) Pub. No.: US 2012/0078730 A1
(43) Pub. Date: Mar. 29, 2012

(54) Automatic Internet Search Advertising Campaign Variable Optimization for Aiding Advertising Agency Efficiencies

(76) Inventors: Viswanathan Ramaiyer, Bangalore (IN); Hastagiri Parkash, Bangalore (IN); Amit Kumar Verma, Bangalore (IN)

(21) Appl. No.: 12/893,465

(22) Filed: Sep. 29, 2010

(51) Int. Cl. G06Q 30/00

(52) U.S. Cl. 705/14.71

(57) ABSTRACT

A method, computer readable medium, and advertising server network for automatic internet advertising campaign variable optimization. The advertising server network comprises a module for receiving an advertising campaign specification containing a keyword template. The keyword template contains a plurality of keywords or bid phrases (which are selected to correspond to a particular business type). Then, based on one or more selected keywords, a module serves for collecting historical and/or forecasted keyword click data using a historical dataset. The keywords and click data are used as inputs into a linear programming optimization problem, which linear programming optimization technique is employed for calculating a bid amount for bidding on one or more display positions. The bid is optimized based an objective function subject to policy constraints. Given an optimized bid, a module places the bid using an auction server. A winning bid then secures a particular position on the internet advertising impression.

### FIELD OF THE INVENTION

The present invention is directed towards internet search advertising, and more particularly to techniques for optimizing bidding for internet search advertising agencies.

### BACKGROUND OF THE INVENTION

Search engines continue to serve as the preferred tool for finding local business information on the internet. For example, an internet search for a “shoe store in Memphis” is likely to yield dozens of shoe stores in Memphis, Tenn., and the search results page is likely to include maps and telephone numbers. Such localized internet searches for local business information is expected to play an even greater role as time progresses. With the explosion of the deployment of highly-capable mobile terminals (e.g. smart phones, phones with large screens, touch screens, etc), the contribution of searches for local business information now accounts for 35% of all mobile searches. The current generation of mobile terminals exhibits sufficient computing and display resources to make those mobile terminals good platforms for advertisements to be displayed on the mobile terminal screen (e.g. the screen of the smart phone). Local advertisements play an important role in “Research Online, Buy Offline” (ROBO) behavior. Yet, despite all these favorable factors, local businesses continue to spend a disproportionate amount of advertising dollars on mediums other than display advertising.

Studies suggest that small, local businesses are often owned and managed by a sole proprietor or are family businesses, and accordingly such local businesses do not employ staff with sufficient skills to deal with the nature and complexities of internet search advertising. Moreover, even in the case that a small business would seek to engage an advertising agency, the agency might not find that the sector of such small, local businesses would be a profitable sector. That is, the cost of set-up of a client account, the cost of engaging small business personnel to determine differentiating factors, the cost of engaging small business personnel to determine appropriate keywords and bid amount, etc, might present more costs per account than can be expected to be recouped, and also increases the timeframe for the account to reach profitability. Earlier techniques that merely provide un-optimized “one size fits all” solutions have proven to be inadequate for the needs of local businesses, and also have proven inadequate for the needs of advertising agencies that seek to serve local businesses.

Thus, for this and other reasons, techniques for internet search advertising campaign variable optimization for aiding advertising agency efficiencies are needed. Key reasons are:
Keyword bidding is complex; it is not the kind of activity one can expect typical local businesses to handle. They will need the help of a search reseller.
The kind of earnings a search reseller can expect from a single typical local business is rather small, of the order of a few hundred dollars. However, servicing a large number of small, local businesses could make local search ad marketing sector look attractive to the reseller. Even premium ad agencies can be expected to be interested in such a business opportunity. However, the management overhead (i.e. start-up costs) needs to be overcome for this sector to become viable.

If the reseller can be helped with the management overhead issues involved with handling numerous clients, then the local search ad market can be stimulated to realize its full potential. Techniques described herein address keyword management, especially around managing keyword templates or lists and especially around techniques for bidding on behalf of a very large number of clients (i.e. on the order of hundreds of thousands of clients). Thus, for these and other reasons, techniques for automatic internet search advertising campaign variable optimization for aiding advertising agency efficiencies are needed.

### SUMMARY OF THE INVENTION

A method, computer readable medium, and advertising server network for automatic internet search advertising campaign variable optimization (which advertising campaign variables may be generated using templates or other automation techniques). The advertising server network comprises a module for receiving an advertising campaign specification containing a keyword template. The keyword template contains a plurality of keywords or bid phrases (which are selected to correspond to a particular business type). Then, based on one or more selected keywords, a module serves for collecting historical and/or forecasted keyword click data using a historical dataset. The keywords and click data are used as inputs into a linear programming optimization problem, in which linear programming optimization technique is employed for calculating a bid amounts for bidding on one or more display positions. The bid amounts are optimized based an objective function subject to policy constraints. Given an optimized bid, a module places the bid using an auction server. A winning bid then secures a particular position on the internet search advertising impression.

### BRIEF DESCRIPTION OF THE DRAWINGS

The novel features of the invention are set forth in the appended claims. However, for purpose of explanation, several embodiments of the invention are set forth in the following figures.

FIG. 1A depicts a forecasting graph of costs vs. clicks, according to an exemplary embodiment.

FIG. 1B depicts a forecasting graph of CPC vs. clicks, according to an exemplary embodiment.

FIG. 1C depicts a screen device with a multi-step procedure for creating a campaign, according to an exemplary embodiment.

FIG. 1D depicts a screen device for a campaign set-up procedure for defining a geographic scope of an advertising campaign, according to an exemplary embodiment.

FIG. 1E depicts a screen device for a campaign set-up procedure for defining keywords for an advertising campaign, according to an exemplary embodiment.

FIG. 1F depicts a screen device for a campaign set-up procedure for selecting keywords, according to an exemplary embodiment.

FIG. 1G depicts a screen device for a campaign set-up procedure for defining advertising spending constraints for an advertising campaign, according to an exemplary embodiment.

FIG. 1H depicts a data structure for an advertising campaign specification, according to an exemplary embodiment.

FIG. 2 depicts an advertising server network including modules for display advertising campaign variable optimization for aiding advertising agency efficiencies, in which some embodiments operate.

FIG. 3 depicts a series of linear constraints on two variables X and Y plotted along the X-coordinate (abscissa) and Y-coordinate (ordinate) to produce a region of feasible values for those variables, according to one embodiment.

FIG. 4 depicts an embodiment of a system for automatic display advertising campaign variable optimization implemented using multiple computation servers, according to one embodiment.

FIG. 5 depicts a block diagram of a system for automatic display advertising campaign variable optimization, according to one embodiment.

FIG. 6 depicts a diagrammatic representation of a network including nodes for client computer systems, nodes for server computer systems and nodes for network infrastructure, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

Some of the terms used herein are presented below. These terms are not rigidly restricted to these definitions. A term may be further defined by the term's use in other sections of this description.

“Advertisement” (e.g., ad, item and/or message) means a paid announcement, as of goods or services for sale, preferably on a network, such as the Internet. An ad may also be referred to as an ad, an item and/or a message.

“Advertiser” (e.g., messenger and/or messaging customer, etc.) means an entity that is in the business of marketing a product and/or a service to users. An advertiser may include without limitation a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a Web site.

“Internet Advertising” means marketing a product and/or service to one or more potential consumers by using an ad delivered over the internet or other network. One example of internet advertising is internet search advertising including publishing a sponsored search ad on a Web site. Another example of internet advertising is internet display advertising including publishing a display ad or message on a Web site. Techniques disclosed herein may be applied to internet advertising in the form of internet search advertising and/or internet advertising in the form of internet display advertising.

Search engines continue to serve as the preferred tool for finding local business information on the internet. Such localized internet search for local business information is expected to play an even greater role as time progresses. Yet, studies suggest that small, local businesses are often owned and managed by a sole proprietor or are family businesses, and accordingly such local businesses do not employ the staff with sufficient skills to deal with the nature and complexities of internet advertising. Moreover even in the case that a small business would seek to engage an advertising agency, the agency might not find that the sector of such small, local businesses would be a profitable sector. That is, the cost of set-up of a client account, the cost of engaging small business personnel to determine differentiating factors, the cost of engaging the small business personnel to determine appropriate keywords and bid amount, and the overall cost of developing an optimized advertising campaign, might present more costs per account than can be expected to be recouped, and also might reduce the probability that the engagement would generate a profit in a reasonable timeframe.

### Campaign Variable Overview

Often, and especially for small businesses, online advertising and marketing campaigns rely at least partially on an auction process where any number of advertisers or their agents submit and authorize highest bids corresponding to keywords or bid phrases, where the bid corresponds to a particular position of the internet search advertisement (e.g. first most prominent position, second most prominent position, etc). Especially in situations where there is limited advertising space available, an auction for a particular bid phrase is held to identify the winning bidder or bidders. The advertisement belonging to the winning bidder (or possibly an ordered list of winning bidders) is used for presenting an impression (e.g. a display of an advertisement or message) within the advertising space. In order to create and optimize an advertising campaign, it is often the case that, in addition to identifying keywords or bid phrases, the advertiser must also create and specify the advertisement to be placed, specify details regarding geographic targeting, specify details regarding time-based targeting, specify details regarding budget, and sometimes must specify many other variables used in the execution of an advertising campaign.

Understanding the meaning and effect of these campaign variables (e.g. keywords, bid phrases, bids, cost-per-click (CPC), conversion rate, keyword bidding methods, ROI, etc) presents entry barriers (at the least, a skill-level barrier) to small advertisers, and presents a business barrier (at the least, a profitability barrier) to advertising agencies.

Worse, a poorly defined or un-optimized campaign might run for some initial period, might result in a poor return on investment to the advertiser, and might risk the result that the advertiser forms a negative opinion about the advertising service provider and/or the advertising agency.

For proving solutions to overcome the aforementioned barriers, it is instructive to further examine aspects underlying the barriers. For example:
Keyword bidding is complex; it is not the kind of activity one can expect typical local businesses to handle. Even when a small business seeks the expertise of an agency (e.g. a search reseller) the agency often must invest time and expertise to bring the small business advertiser to a minimum level of understanding of the operation of an internet advertising campaign.
The magnitude of earnings that an agency can expect from a typical local business is rather small—sometimes only on the order of a few hundred dollars per campaign.
   Even given these barriers, there are a large number of small businesses, and the dollar volume in aggregate can be quite significant in many local markets. Thus, if the costs of defining, optimizing and prosecuting an advertising campaign for a small business could be reduced, then servicing a large number of such small businesses could make the small business (e.g. local search) ad market attractive to the agency. In fact, if certain aspects of defining, optimizing and prosecuting an advertising campaign were automated, it is reasonable to expect even premium ad agencies to be interested in servicing such a business sector serving small, local businesses.

Some work has been done as regards automation of various aspects of campaign generation (e.g. automatic generation of creatives) and campaign variables optimization (e.g. keyword generation and bidding techniques). The disclosure herein focuses on keyword management aspects, and especially addresses techniques for managing keyword lists and managing bidding for a very large number of clients (e.g. on the order of hundreds of thousands of small clients) spread across the globe. Further, effective application of the techniques described herein can result in:
A business model that provides for simplified keyword bidding management through use of click-based offers and keyword list templates.
Automated bid computing (i.e. an algorithm that proposes “optimal” bids to maximize reseller profit under the proposed business model).

### The Business Model

Local businesses are generally price sensitive and expect to see measurable returns on their investments (ROI). On the other hand, tracking leads and conversions in the small business and local business context is challenging to measure because many of the businesses do not provide for online delivery of their products and services. Further the “Research Online, Buy Offline” (ROBO) behavior continues to be prevalent with respect to small businesses and local businesses. Thus, campaign results based on clicks would be a reasonable opening option. It should be noted that the techniques disclosed herein can be applied to other models such as cost-per-lead (CPL) or cost-per-acquisition (CPA) pricing.

### Creation and Presentation of an Advertising Campaign

In exemplary embodiments, a internet search advertiser and/or agency provides forecasting graphs such as of the form of bid vs. clicks, bid vs. cost-per-click, clicks vs. cost-per-click, etc. Such forecasting graphs can be provided as it pertains to each and every keyword or bid phrase for which such data has been captured (historically) to the extent a forecast can be provided. These graphs are typically aggregated at daily/weekly/monthly levels. From these graphs and others like them, one can ascertain the number of clicks one can expect to realize for a particular bid value over the defined period.

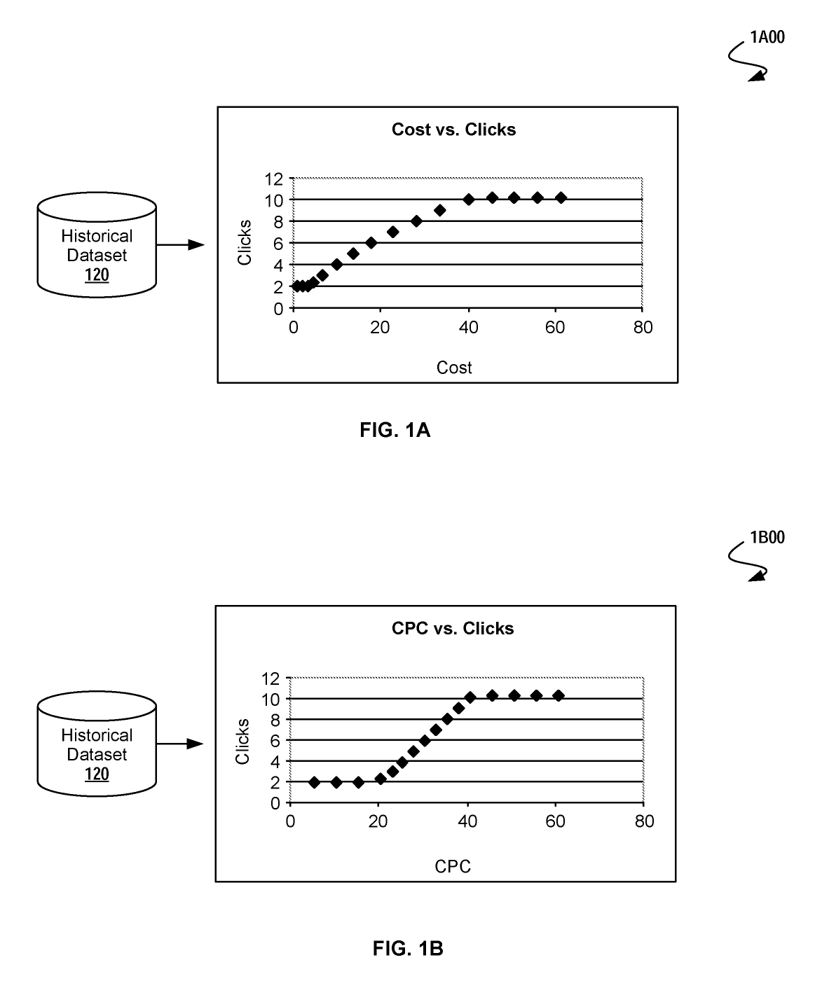

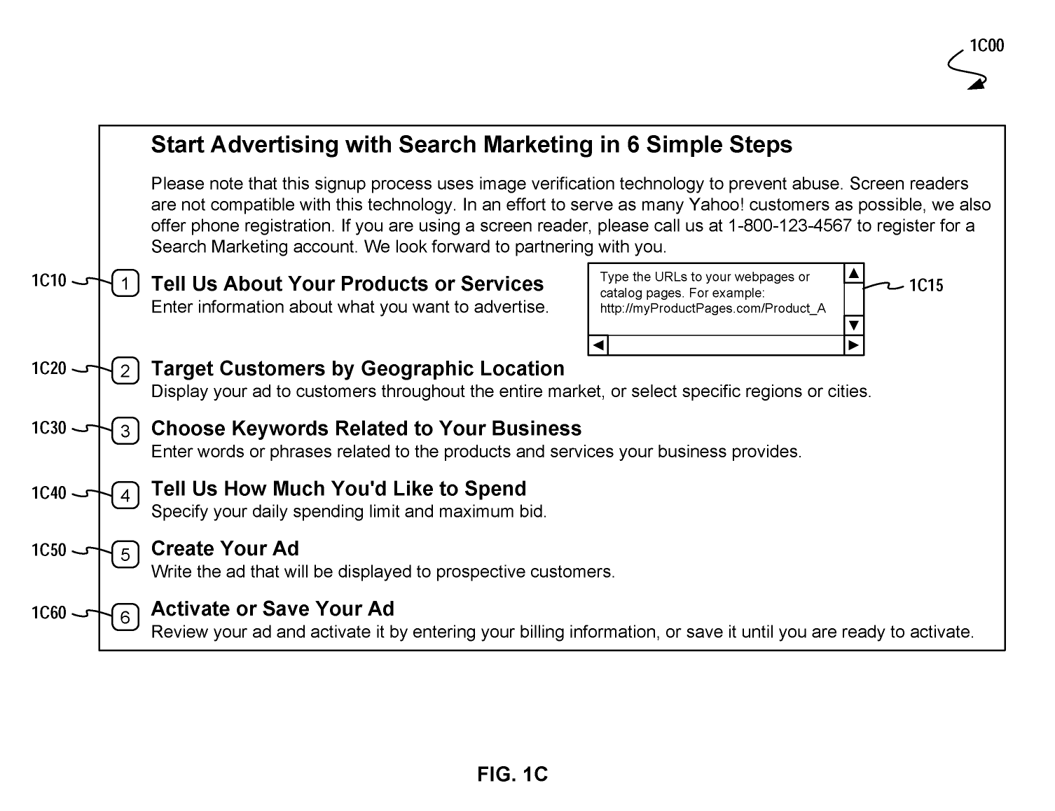

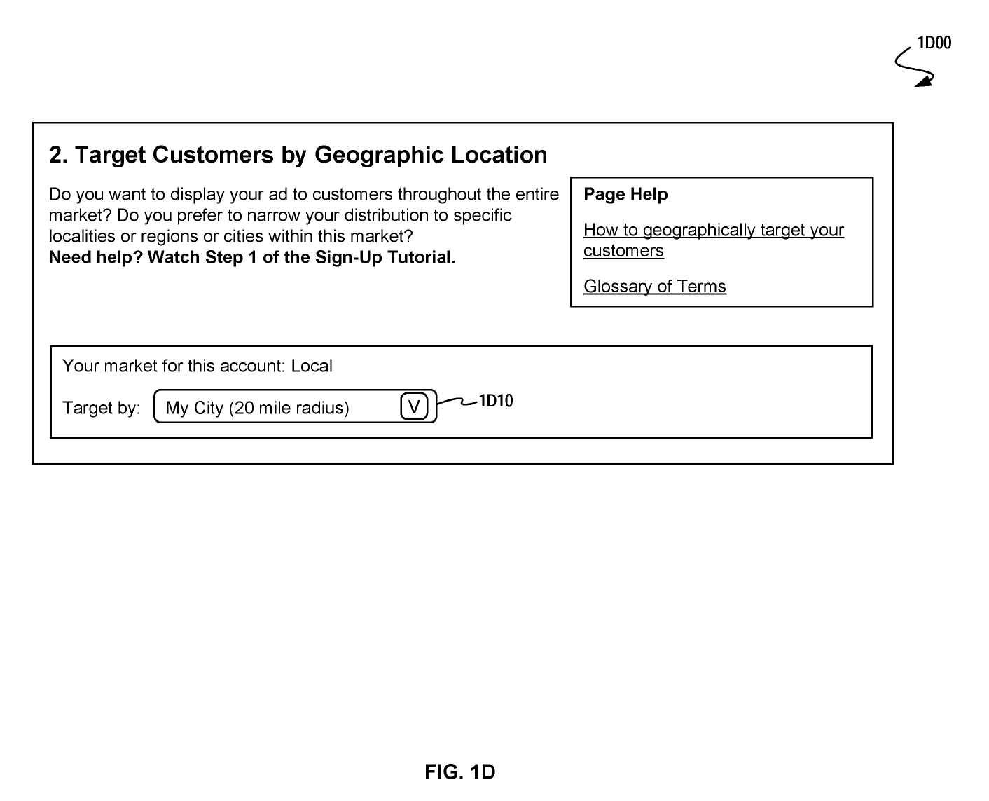

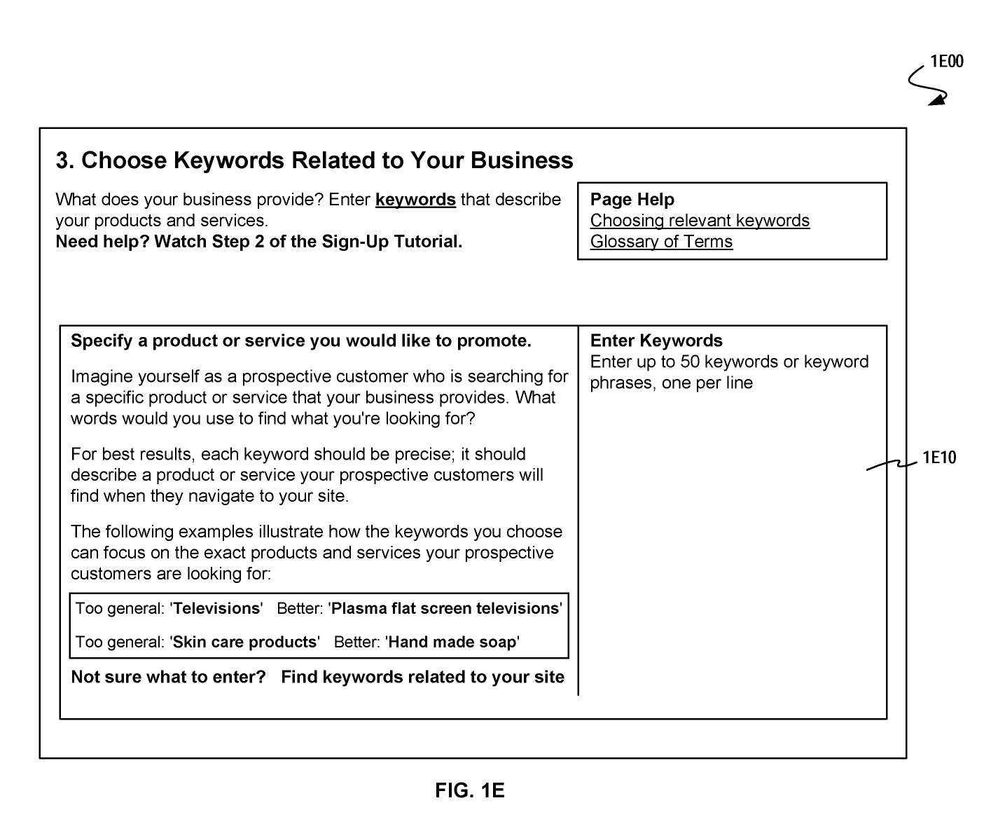

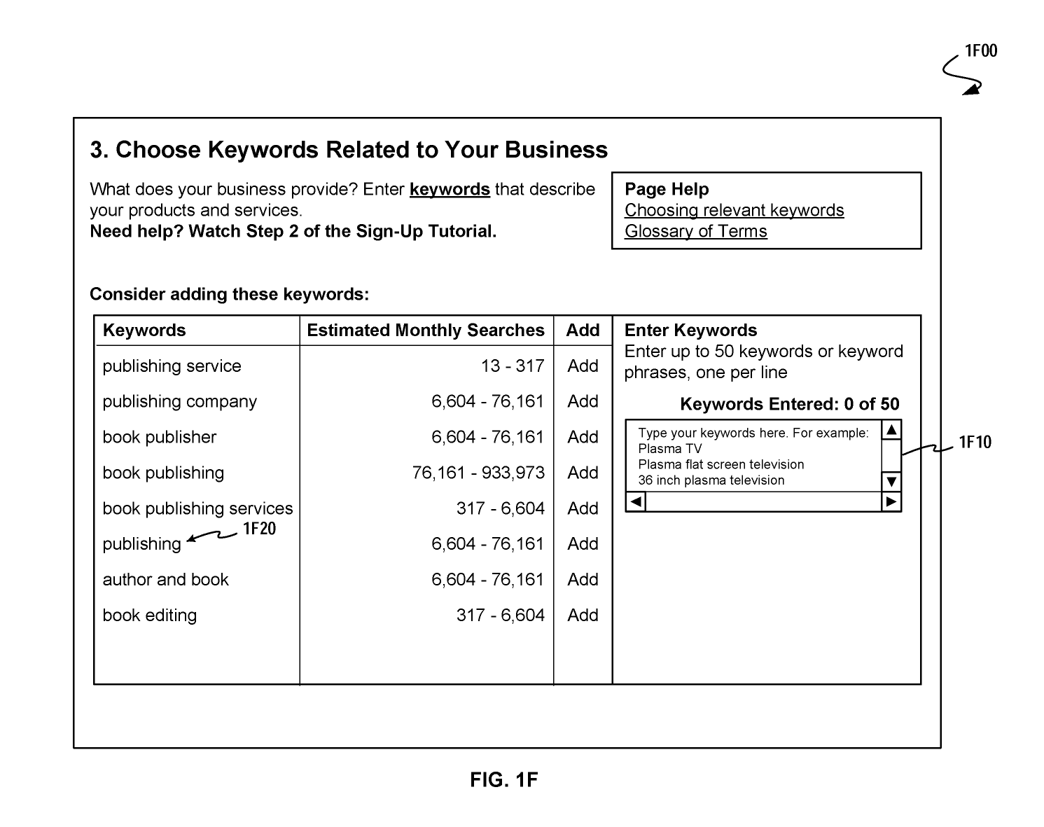

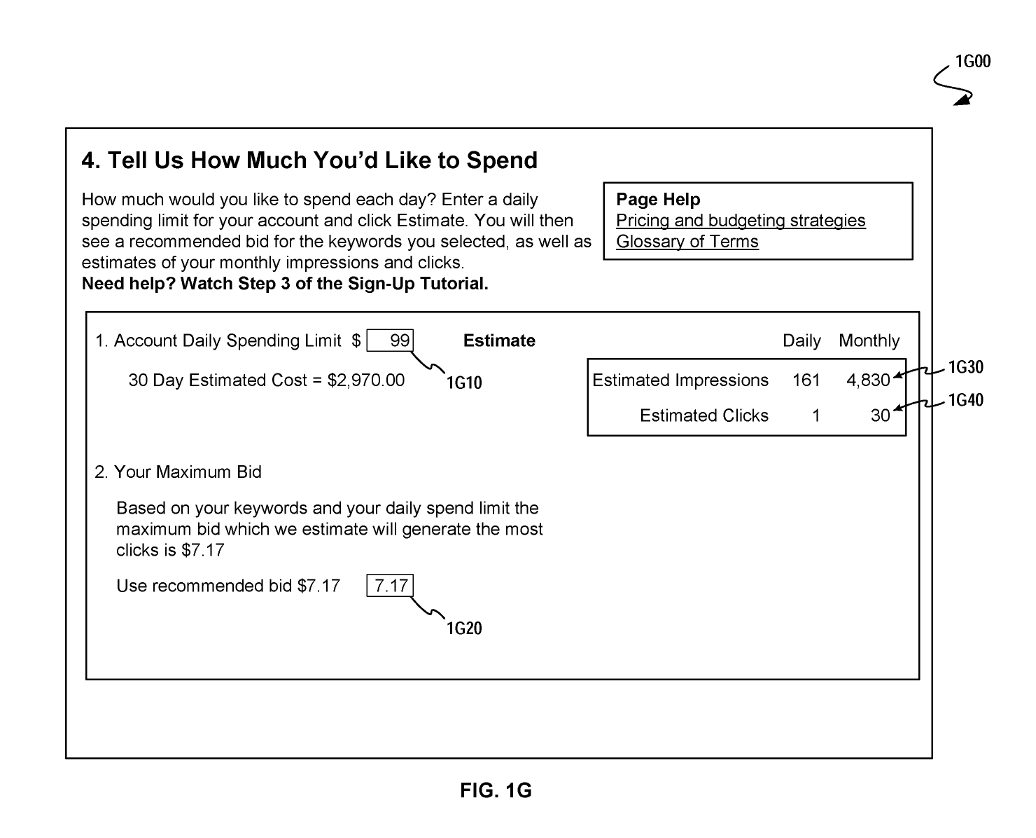

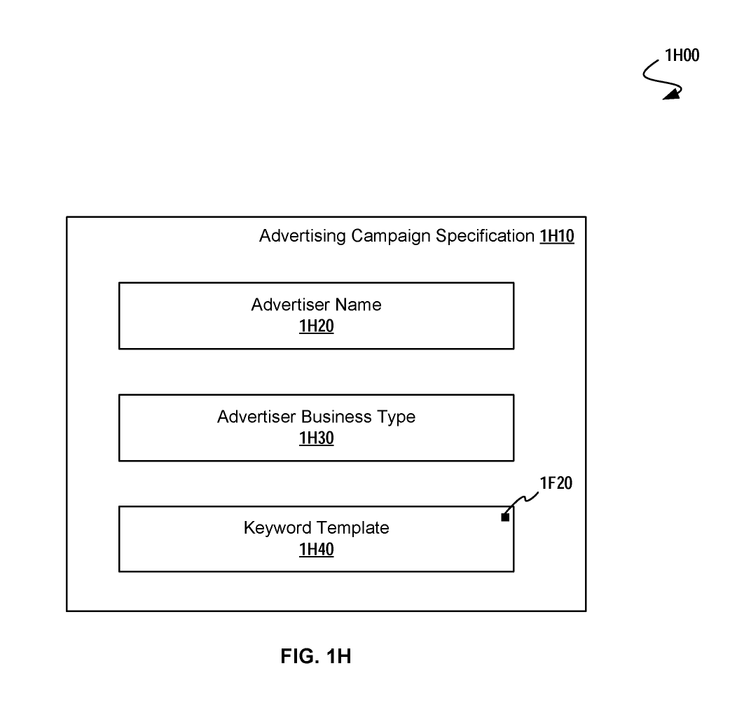

FIG. 1A depicts a cost versus clicks forecasting graph 1A00 showing a forecast of clicks as a function of cost, as extracted and inferred from historical dataset 120 (and containing historical cost of a click). As shown, as the bid amount increases, so does the number of clicks that an advertiser receives. Accordingly, an advertiser is compelled to submit higher bids, up to a saturation point. The example 1A00 is a generic example of a forecasting graph based on keyword-specific historical dataset.

FIG. 1B depicts a CPC versus clicks forecasting graph 1B00 showing a forecast of clicks as a function of cost-per-click, as extracted from historical dataset 120. As shown, as the cost-per-click increases, so does the number of clicks that an advertiser receives. Accordingly, an advertiser is compelled to submit higher bids, up to a saturation point, where the marketplace (based on a second price auction) dominates the shape of the curve. Observe that over a certain range, the number of clicks increases as CPC increases. The points with lower CPC correspond to lower positions in the ad listing, and vice versa for the points with higher CPC. The example 1B00 is a generic example of a forecasting graph based on keyword-specific historical dataset.

As an example of the level of sophistication required for proposing and optimizing campaign variables, consider that, given a particular budget (e.g. daily, weekly, monthly budget), the campaign manager, using forecasting graphs (such as is shown in FIG. 1A and FIG. 1B) should find a set of keywords or bid phrases for which bids, if placed within the forecasted period, would maximize the number of clicks obtained without exceeding the budget amount. Still more sophistication is brought to bear when considering that the advertising campaign manager seeks to arrive at a selection of keywords and bid phrases that would maximize the number of clicks while keeping the overall CPC value under some advertiser-defined threshold.

In some embodiments, various screen devices are provided for an advertiser (or agent) to capture elements of such an advertising campaign.

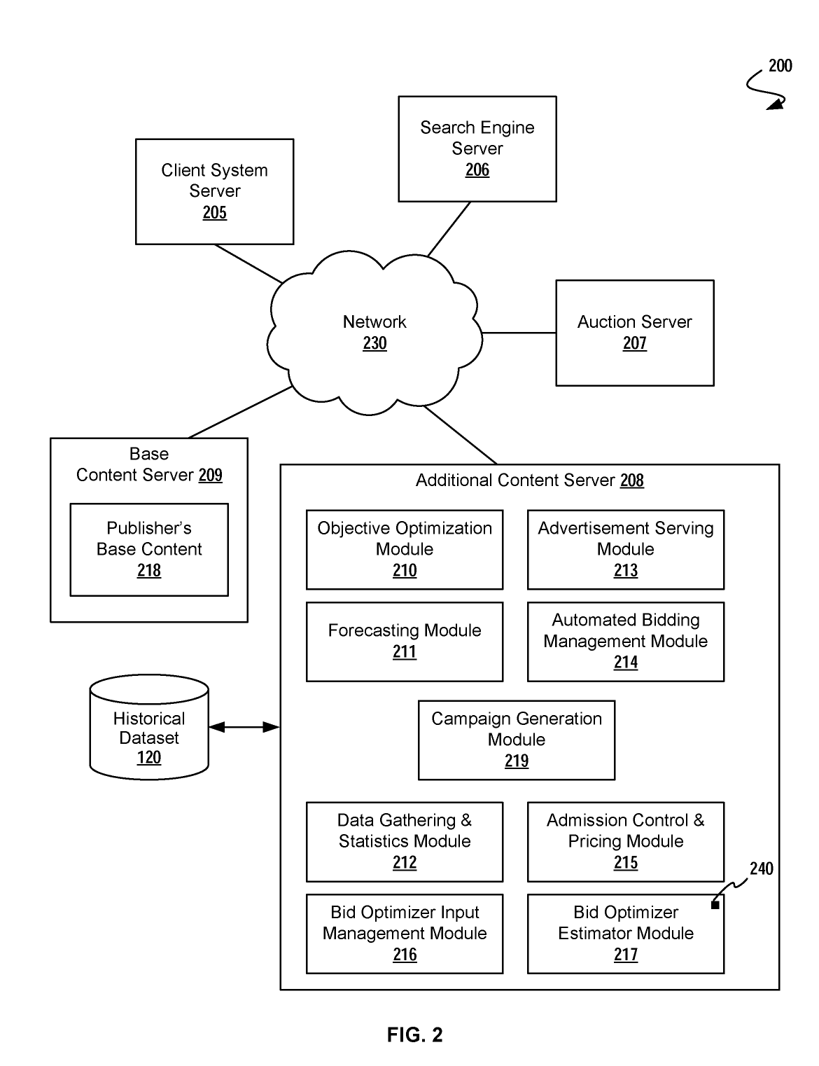

FIG. 1C depicts a screen device 1C00 a multi-step procedure for defining variables within an advertising campaign, according to an exemplary embodiment. As shown, the steps for defining variables within an ad campaign might include providing some initial information about the products or services to be advertised 1C10, establishing geographic coverage 1C20, defining keywords and bid phrases 1C30, defining advertising spend- and budget-oriented constraints 1C40, creating advertising copy and advertising imagery 1050, and activating and/or saving the campaign 1060 variables. In various embodiments, one or more of the steps 1C10-1C60 might be performed on the basis of user interaction from a client system server 205 (see FIG. 2). In other embodiments one or more of the steps 1C10-1C60 might be performed either fully automatically, or in a computer-aided manner by use of an additional content server 208. In an exemplary embodiment, the step providing some initial information about the products or services to be advertised 1C10 might include a screen device 1C15 for requesting a user to merely identify a web page that features the products or services to be advertised. Of course a wide range of information about the subject product or service might be retrieved from the identified web pages, including information on geographic location, appropriate geographic scope, keywords, images and style for creative advertisement generation, and even budget-related constraints or variables.

FIG. 1D depicts a screen device 1D00 for a campaign variable set-up procedure for defining a geographic scope of an advertising campaign, according to an exemplary embodiment. As shown, a field, namely “Target by:” 1D10 might be populated manually via a pull-down menu or other screen device, or it might be populated either fully automatically, or via a computer-aided manner by the additional content server 208. Or, of course, it might be populated automatically by a campaign generation module 219.

FIG. 1E depicts a screen device 1E00 for a campaign set-up procedure for defining keywords and/or bid phrases for an advertising campaign, according to an exemplary embodiment. As shown, a variable field, namely field 1E10, might be populated manually via user input into a text field or other screen device, or it might be populated either fully automatically, or in a computer-aided manner by the additional content server 208 possibly in conjunction with a campaign generation module 219. It should be emphasized that any manually entered information might be used in conjunction with a campaign generation module 219. In fact, heuristics followed by operations in a campaign generation module 219 might employ user-specified information to drive assessment of a user-specified product or service web page, or possibly to ratify or score candidate extractions from such a user-specified product or service web page. Candidate keywords or combinations of keywords or bid phrases might be retrieved from one or more keyword templates. Or, candidate keywords or combinations of keywords or bid phrases might be retrieved from a prospective advertiser's product or service web pages, auto-populated into the field 1E10 (or into some underlying database), and later used when selecting a keyword template.

As shown, a screen device 1E00 might provide tips, hints, page help, and/or other resources to aid the user in completing (e.g. in cases of manually entered information) or in accepting (e.g. in cases of computer-aided information population) any entered information. Further, some embodiments might provide one or more screen devices to aid an advertiser. As shown, the button “Find keywords related to your site” 1E20 might be presented to an advertiser, and clicking the button might invoke one or more operations within a campaign generation module 219, for example, the button “Find keywords related to your site” might be used for operations to select a keyword template.

FIG. 1F depicts a screen device 1F00 for a campaign variable set-up procedure for selecting keywords. As shown, a field of variables, namely field 1F10 might be populated manually via a text field or other screen device, or it might be populated either fully automatically, or in a computer-aided manner by the additional content server 208. Of course, any estimates presented might be calculated specifically in regard to a geographic scope as may have been defined in any previous steps. Moreover, it should be noted that given a correspondence between a keyword or bid phrase and its corresponding estimated monthly search magnitude, the number of measured searches per month for any given keyword or combination of keywords can be retrieved from a historical dataset 120 (or can be forecasted based on a historical dataset).

FIG. 1G depicts a screen device 1G00 for a campaign set-up procedure for defining advertising spending constraints for an advertising campaign, according to an exemplary embodiment. As shown, one or more fields, namely fields 1G10 and 1G20, might be populated manually via a text field or other screen device, or it might be populated either fully automatically, or in a computer-aided manner as populated by the additional content server 208. Similarly, one or more fields, namely fields in lines 1G30 and 1G40 might be presented to a user via a text field or other screen device, or it might be populated either fully automatically, or fields in lines 1G30 and 1G40 might be calculated by the additional content server 208, and possibly used in further calculations, perhaps without ever being presented to the user. It should be noted that given a correspondence between a keyword or bid phrase and its corresponding maximum bid magnitude, the number of internet search advertising impressions per month for any given budget can be calculated. Still further, various statistics, for example statistics captured by any or all servers (e.g. a search engine server 206, a auction server 207, an additional content server 208, a base content server 209, see FIG. 2) or any other server might be used to represent a statistically reliable number of clicks per impression (e.g. click rate). Thus, given a particular budget constraint (e.g. dollars per month), a campaign using specific bid phrases might be constructed automatically by first selecting the most targeted bid phrases (e.g. most targeted to the specific product or service) and continuing to add more, successively less targeted bid phrases to the campaign until the estimated spend approaches the prospective advertiser's suggested budget. Of course optimizing on the basis of bid phrases, number of internet search advertising impressions, conversion ratio, and cost-per-click costs are but a subset of the campaign variables that can be fine-tuned in the context of optimizing a campaign. Other optimization techniques include optimizing for geographic scope, optimizing for time zones and related presentation of impressions, and any other campaign variables, regardless of whether such a campaign variables is explicitly provided by an advertiser, or whether such a campaign constraint or variable is derived by any operation of system 200.

FIG. 1H depicts a data structure for an advertising campaign specification. As shown, the advertising campaign specification 1H10 comprises an advertiser name 1H20, an advertiser business type 1H30, and a keyword template 1H40. Among these, the keyword template 1H40 may be extracted from another template, namely a reseller offer template (not shown).

### The Reseller Offer Template

As can be understood from the foregoing descriptions of campaign screen devices, and the consideration of the values captured by those screen devices, advertising agencies are motivated to automate and/or simplify the process. One such simplification involves a change to the business model, namely, a business model such that resellers may make offers of clicks per month at a certain price, such as “500 clicks per month for $800”. Typically “branding” (e.g. delivering as many display advertising impressions as possible) is not a goal for local businesses, therefore such click-based pricing serves small and local business needs. It is also simple and easily understood by even an unsophisticated campaign manager (e.g. a small business sole proprietor). As a further example, consider the scenario of dentists (i.e. a local business) being offered an advertising campaign with “template proposals” containing click offers such as, “800 clicks at $1000”, “500 clicks at $800” and “300 clicks at $500”. Mechanisms for defining such template proposals is discussed infra

### Keyword List Template

A template-based campaign proposal further suggests that resellers use a single template to manage keywords for all local businesses of a certain advertiser business type 1H30 across all locations within a particular geography, for example “business type” can be dentists, florists, etc). Thus, the management expense (investment) of defining the keyword list template is amortized across all local businesses of a certain advertiser business type 1H30, and across all locations being served by the reseller. The intuitive sense of this is as follows: Consider the example of dentists. How different are the dentists that are located in San Jose from each other? Or, for that matter, how different are dentists located in San Jose from dentists located in San Francisco? Thus, using the same keyword or bid phrase list (e.g. “tooth extraction”, “root canal”, “teeth whitening”, etc) would allow a reseller to scale across all dentists within a particular geography. Further, the techniques disclosed herein facilitate handling a group of clients of a certain business type together during bid optimization.

### Keyword Bidding

Given that supply (e.g. availability of impressions) and demand (e.g. a bid for an ad placement into that impression) are different in different locations, the techniques for automatic internet advertising campaign variable optimization may compute keyword bids for each location separately. In one embodiment, the bid computing algorithm makes use of various policies when calculating the optimal result. For example:
Keyword List Templates Policy: Given a particular business type (e.g. dentists), all keywords are common across all advertisers within the particular business type, and the keywords correspond to the keyword list template for that business type.
Rotation Policy: A reseller or agency can bid on multiple ads to be placed on the same internet advertising impression. For example, reseller can bid for positions 2 and 5 for two different dentists from San Jose on a search results page pertaining to dentists from San Jose. A different approach might be to bid for just one position and then rotate the ads for the two dentists in a rotation schedule that is substantially proportional to the click-related variables in their corresponding campaigns.
Position Policy: Within a second-price auction, a reseller would not bid for the same position on behalf of more than one client in the same internet advertising impression. As an example, suppose a position 1 bid is currently at $2. If a reseller bids $2 for two different dentists, it means that the dentist at the top position will necessarily need to pay $2 for a click as $2 is also the second highest bid for this position (this is how a second-price auction works). Note that the simpler policy of considering each client independently would quite likely place into bidding competition multiple clients bidding for the same position—a situation that would tend to reduce efficiencies.

The above policies would tend to increase the overall demand that a reseller can place against available supply in that more click demand can be satisfied against the existing supply, thus increasing reseller revenue. Further, the above policies tend to increase the profit margin for the reseller, given the increased efficiency of placing multiple ads on the same internet advertising impression.

### Internet Search Advertising System Host for the Bid Optimizer Modules

FIG. 2 depicts an advertising server network including modules for advertising campaign variable optimization for aiding advertising agency efficiencies, in which some embodiments operate.

### Overview of Networked Systems for Online Advertising

In the context of internet advertising, placement of advertisements within an internet environment (e.g. online advertising system 200 of FIG. 2) has become common. An internet advertiser or agent may select a particular property (e.g. Yahoo.com), and may create an advertisement such that whenever any internet user, via a client system server 205, renders the web page from the selected property, possibly using a search engine server 206, the advertisement is composited on the web page by one or more servers (e.g. a base content server 209, an additional content server 208) for delivery to a client system server 205 over a network 230. Given this generalized delivery model, and using techniques disclosed herein, sophisticated online advertising might be practiced.

Again referring to FIG. 2, an internet property (e.g. a publisher hosting the publisher's base content 218 on a base content server 209) might be able to measure the characteristics of visitors (which visitors may have any arbitrary interest, demographic, target predicates, or other attributes) possibly using an additional content server 208 in conjunction with a data gathering and statistics module 212, and possibly also using historical dataset 120 as pertains to user behavior observed at search engine server 206. Thus, an internet user's demographics and interest might be ‘known’ in quite some detail as pertains to a wide range of user queries, interest categories, or other demographics or attributes. Also, behaviors (e.g. the likelihood of a click or other measurable event) might be known in quite some detail, not only for a particular user, but also for a group of users corresponding to a particular slice of the available data. Such characteristics (i.e. one or more characteristics) and/or features can be used in the statistical modeling of users, even to the extent that a forecasting module 211, possibly in conjunction with a data gathering and statistics module 212 can forecast future supply accurately—at least to a statistically known degree.

In some embodiments, the online advertising system 200 might host a variety of modules to serve management and control operations (e.g. an objective optimization module 210, a forecasting module 211, a data gathering and statistics module 212, an advertisement serving module 213, an automated bidding management module 214, an admission control and pricing module 215, etc) pertinent to serving advertisements to users. In particular, the modules, network links, algorithms, assignment techniques, serving policies, and data structures embodied within the online advertising system 200 might be specialized so as to perform a particular function or group of functions reliably while observing capacity and performance requirements. For example, a campaign generation module 219, a bid optimizer input management module 216 and/or a bid optimizer estimator module 217 can operate partly in an offline (or batch) mode, and partly in an online (or interactive) mode. Further, a database for storing the historical dataset 120 (which can also store historical keyword click data and/or forecasted keyword click data) can operate in an online mode or in an offline mode, or both. As shown, and without regard to allocation of any particular operation to any particular mode, a bid optimizer input management module 216, and a bid optimizer estimator module 217, possibly using a linear program solver 240, can operate cooperatively to implement a system for advertising campaign variable optimization for aiding advertising agency efficiencies.

### The Bid Optimizer Modules

Some embodiments herein disclosed provide a linear programming (LP) formulation of the problem, which formulation is for use by a linear program solver 240. As introduced in FIG. 2, the forecasting module might produce forecast data for retrieving keyword-specific forecasts covering a certain period such as “the next two weeks”. The demand is expressed in the form of how many clicks each advertiser (e.g. a local business client) requests over the period of a campaign. For this illustration, assume for simplicity that the period is the same as the period used in the forecasting graphs mentioned above. The optimizer will find the least cost set of clicks to meet the demand. Note that the amount paid from each advertiser is not required as input.

### Bid Optimizer Estimator Module

Within online advertising system 200, a bid optimizer estimator module 217 may operate for implementing advertising campaign variable optimization. In particular, a bid optimizer estimator module 217 may accept inputs from a bid optimizer input management module 216 for performing calculations, including the calculations as are disclosed just below. As foreshadowed above, some embodiments of the bid optimizer estimator module may employ techniques based on linear programming. Linear programming is a mathematical method for determining a way to achieve an optimal outcome (such as maximum profit or lowest cost) given a mathematical model based on linear equations. More formally, formulating a linear programming optimization problem is a technique whereby the optimization of a linear objective function, subject to linear equality and/or linear inequality constraints is solved using a system of simultaneous linear equations.

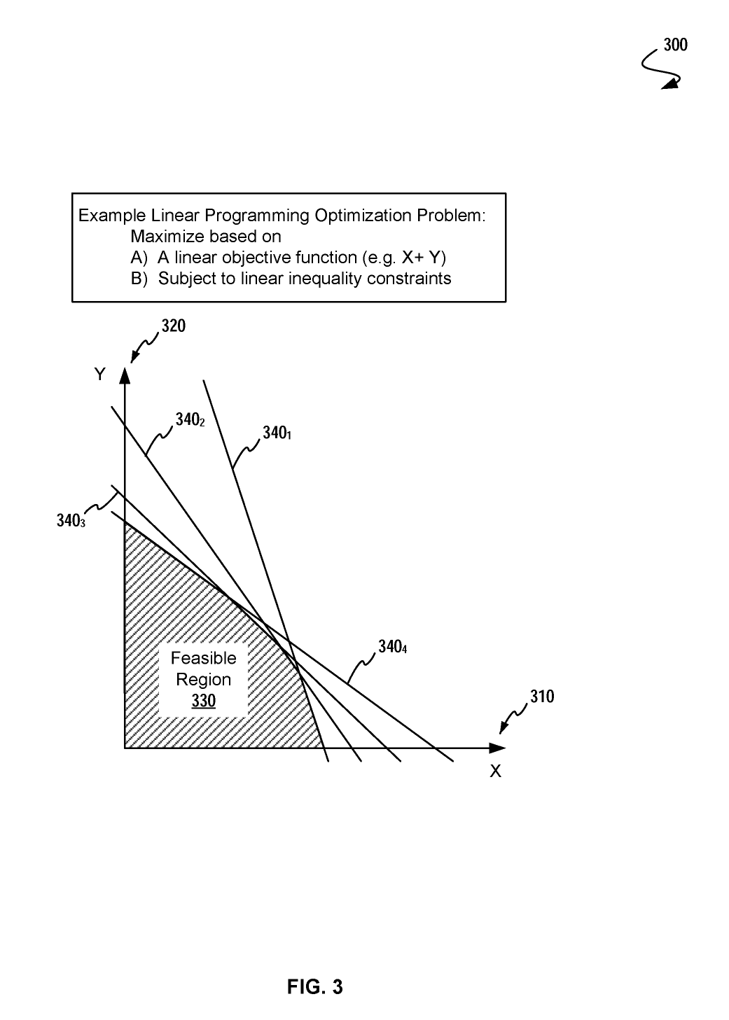

FIG. 3 depicts a series of linear constraints on two variables X and Y plotted along the X-coordinate (abscissa) 310 and Y-coordinate (ordinate) 320 to produce a region of feasible (i.e. satisfying the constraints) values for those variables (shown as feasible region 330). Problems solvable using LP techniques will have a feasible region in the shape of a polygon. In the example shown in FIG. 3 the constraints include linear constraints shown as lines (e.g. 340₁, 340₂, 340₃, and 340₄) plotted on the graph, and bounding the feasible region. The constraints also include the inequality that the variables X and Y must each be non-negative.

Linear programs are problems that can be expressed in canonical form:
Maximize: c^{T}x
Subject to: Ax≦b.
   where x represents the vector of variables (to be determined), c^{T} and b are vectors of (known) coefficients, and A is a (known) matrix of coefficients. The expression to be maximized or minimized is called the objective function (c^{T}x in this case). The equations Ax≦b are the constraints which specify a convex polytope over which the objective function is to be optimized.

Intuitively, given a polytope and a real-valued affine function defined on this polytope, a linear programming method will find a point on the polytope where this function has the smallest (or largest) value (if such a point exists), by searching through the polytope vertices.

Geometrically, the linear constraints define a convex polytope, which is called the feasible region. A linear function is a convex function, which implies that every local minimum is a global minimum; similarly, a linear function is a concave function, which implies that every local maximum is a global maximum.

Optimal solutions need not necessarily exist for two reasons. First, if two constraints are inconsistent, then no feasible solution exists. For instance, the constraints x≧2 and x≦1 cannot be satisfied jointly; in this case, it is said that the LP problem is infeasible (at least so long as the problem includes inconsistent constraints). Second, when the polytope is unbounded in the direction of the gradient of the objective function (where the gradient of the objective function is the vector of the coefficients of the objective function), then no optimal value is defined (although the system may possess many feasible solutions).

If a feasible solution exists and if the (linear) objective function is bounded, then the optimum value is always attained, on the boundary of optimal level-set, by the maximum principle for convex functions (alternatively, by the minimum principle for concave functions). Some problems have multiple distinct optimal solutions: For example, the problem of finding a feasible solution to a system of linear inequalities is a linear programming problem in which the objective function is the zero function (that is, the constant function taking the value zero everywhere). For this feasibility problem with the zero-function for its objective function, if there are two distinct solutions, then every convex combination of the solutions is a solution.

Now, with an understanding of the characteristics and mathematical notation of an LP problem, and further that the objective of the reseller is to minimize the total cost of procurement of all the required clicks of all the advertisers, then the problem of internet advertising campaign variable optimization for aiding advertising agency efficiencies can be described with the notation and meaning as follows:

TABLE 1
Notations

| | |
|---|---|
| Advertiser set | {1 . . . n} denoted by i |
| Keyword set | {1 . . . m} denoted by j |
| Click target of advertiser i | tᵢ |
| Positions available at keyword j | {1 . . . lⱼ} denoted by kⱼ |
| Cost of all clicks at position kⱼ of keyword j | cⱼₖ_{ⱼ} |
| Clicks from position kⱼ of keyword j | pⱼₖ_{ⱼ} |
| Fraction to bid at position kⱼ of keyword for | Xᵢⱼₖ_{ⱼ} |
| advertiser i | |

Those skilled in the art will recognize the following:
Following the Rotation Policy, multiple advertisers are considered in the optimization problem formulation, hence the notation of the advertiser, denoted as i.
Following a Keyword List Template Policy, a particular keyword set is the same for all advertisers within the same business type (e.g. dentists), hence the notation of the advertiser, denoted as j.
The click target of a particular advertiser within the Advertiser set is denoted tᵢ.
Following the Position Policy, a position available for keyword j (i.e. {1 . . . 1j}) is denoted kⱼ.
The cost of all clicks at a particular position can be obtained by multiplying the number of clicks by the cost-per-click for the particular position. This quantity is used in calculations below and is denoted as per Table 1.
The fraction x (or proportion) to bid at a position refers to what fraction of the period under consideration should the advertiser bid for the keyword. For example, a fraction of 0.33 means that the advertiser will bid for this keyword ⅓ of the period (in aggregate). The policies allow different advertisers to bid for the same position during different time periods, but disallows two advertisers to bid simultaneously for the same keyword/position. The fraction must be between 0 and 1.

Thus, xᵢⱼₖ_{ⱼ} represents the unknowns to be determined by the bid optimizer estimator module 217. Once these values are computed, computing an actual schedule can be performed.

### LP Problem Formulation

The objective of the reseller, as stated earlier, is to minimize the total cost of procurement of all the required clicks of all the advertisers. This translates into an objective function of the form:

min ΣΣΣxᵢⱼₖ_{ⱼ}cⱼₖ_{ⱼ}

That is, minimize the sum of all individual costs of advertisers who have to pay xᵢⱼₖ_{ⱼ}*cⱼₖ_{ⱼ} for bidding a proportion, xᵢⱼₖ_{ⱼ}, on the position kⱼ of the keyword j.

Of course feasible solutions are subject to constraints. The first constraint derives from a contract between a particular advertiser and the agent or reseller, the contract specifying a minimum placement policy. That is, the reseller agrees to deliver at least the target number of clicks as required by the advertiser within some specified timeframe (e.g. the time period of the campaign). This constraint is captured by the formula:

∀i, ΣΣxᵢⱼₖ_{ⱼ}pⱼₖ_{ⱼ}≧tᵢ

The next constraint comes from the Position Policy. That is, that the reseller cannot bid the same advertiser for two positions of the same keyword for a given advertising impression. This constraint is captured by the formula:

∀i,j Σxᵢⱼₖ_{ⱼ}≦1

Also, the reseller needs to ensure that the total number of clicks that the set of advertisers derive from each position of each keyword is less than or equal to the total availability at that position. This gives rise to the constraint captured by the equation:

∀j,kⱼΣxᵢⱼₖ_{ⱼ}≦1

Also are constraints which state that each of these quantities xᵢⱼₖ_{ⱼ} must be between 0 and 1:

∀i,j,kⱼxᵢⱼₖ_{ⱼ}≧0, ∀i,j,kⱼxᵢⱼₖ_{ⱼ}≦1

Given this linear programming formulation, various embodiments of a bid optimizer estimator module 217 can use one or more instances of a linear program solver 240 to obtain the optimal values for xᵢⱼₖ_{ⱼ}. An LP solver can also return feasible/infeasible decision for a given scenario. By inspection, if a solution is feasible, it is also bounded since all the variables in the objective function are positive; therefore, the problem is formulated as a minimization problem. In case of infeasibility, the reseller may reduce one of the demand requirements. For example, if a reseller had suggested, “1000 clicks in a month for $1000” the reseller might reduce the offer to “500 clicks in a month for $500”, thus hoping that the less aggressive constraint can be satisfied during the period of the campaign.

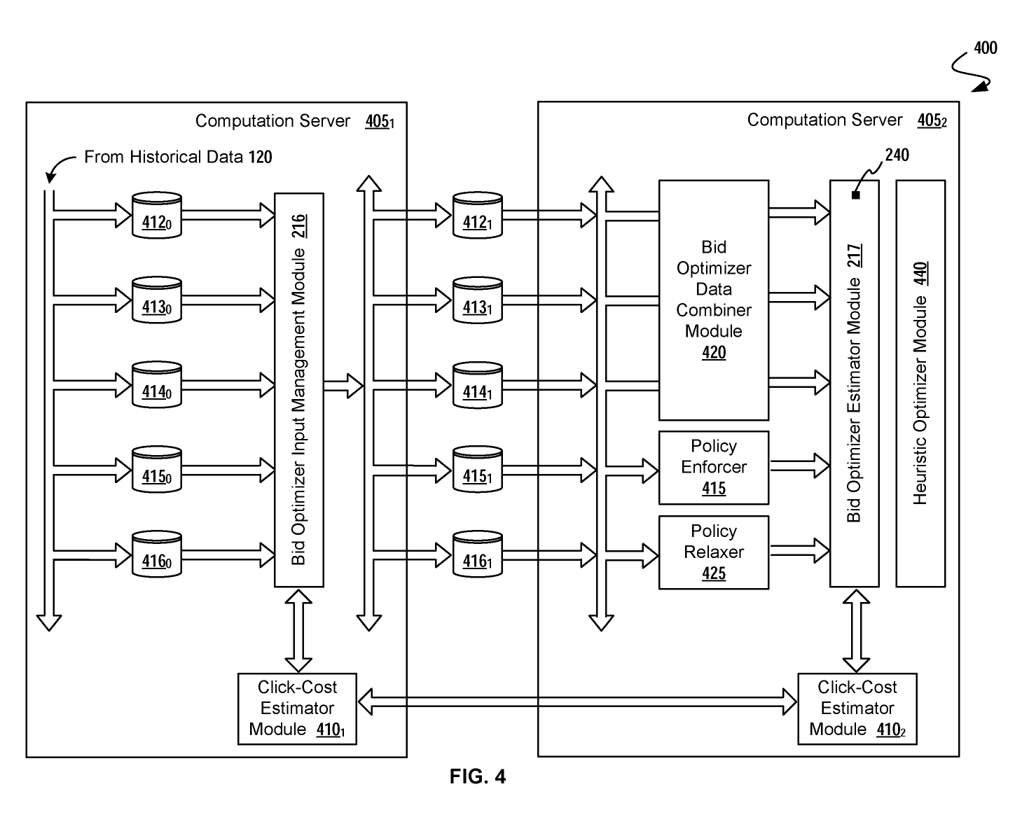

FIG. 4 depicts an embodiment of a system 400 for automatic advertising campaign variable optimization implemented using multiple computation servers, according to one embodiment. As shown, a first computation server 405₁ is in communication with a second computation server 405₂. A bid optimizer input management module 216 takes data from a plurality of sources, namely, a dataset of local advertisers 412₀, a dataset of keyword templates 413₀, a dataset of contracts 414₀, a dataset of forecasted supply 415₀ (e.g. supply of advertising impressions for a particular keyword or bid phrase), and a dataset of historical keyword click data 416₀ (e.g. performance of a particular keyword or bid phrase relative to clicks or other measured actions). In an exemplary embodiment, a contract (e.g. selected from the dataset of contracts 414₀) relates a particular advertiser to a particular keyword template, and for a specific aggregate price and a duration (e.g. 1000 clicks in June for $1000).

In the embodiment shown, a bid optimizer input management module 216 takes data from the aforementioned plurality of sources and filters and/or reforms the data for processing by a second computation server 405₂, or more particularly by a bid optimizer estimator module 217. As an example of filtering, a bid optimizer input management module 216 can accept a dataset of local advertisers 412₀ and filter those advertisers to retrieve only advertisers of interest. For example, a bid optimizer input management module 216 might filter to produce a dataset containing only dentists within a particular proximity to a city center. Such filtered data can be stored in a dataset accessible to both the first computation server 405₁ and the second computation server 405₂, (for example, in a filtered dataset of local advertisers 412₁). In similar fashion, the bid optimizer input management module 216 might filter and store other data from the datasets.

In an exemplary embodiment, the first computation server 405₁ includes a click-cost estimator module 410. Such a module is designed to help the reseller estimate the market potential in a given location (e.g. in terms of clicks and cost). A reseller might use the outputs of such a module to aid in determining what characteristic should be included in an offer to an advertiser. For example, the reseller might suggest to dentists in San Jose a trial campaign comprising 1000 clicks in the month of June for $1000. Such a click-cost estimator module 410 might be partitioned into two or more components, for example a first click-cost estimator module 410₁ might be implemented within a first computation server 405₁ and a second click-cost estimator module 410₂ might be implemented within a second computation server 405₂. As shown, the second click-cost estimator module 410₂ uses the bid computing algorithm to estimate the cost of meeting certain demand. Given such an estimate, the reseller can create demand profiles and attach the demand profiles to specific locations. Moreover, based on estimates within the demand profile, a reseller or advertiser can deduce various click-cost curves. Furthermore, it is reasonable and conceived to automate this activity such that as soon as a new small business type emerges, a suitable demand profile can be attached to it, the click-cost deduced from historical dataset, and potential offers computed; for example, based on profit margin requirements.

The bid computing algorithm does not necessarily ensure that the client paying the highest pay-per-click to a reseller gets placed higher on the impression over those paying lower amounts to the same reseller. Accordingly, a system 400 for automatic advertising campaign variable optimization can employ a heuristic optimizer module 440 designed to apply heuristics to the results of the bid optimizer estimator module 217. Specifically, by modifying the allocations after the optimized solution is obtained from the bid optimizer estimator module.

Now, combining aspects of the above disclosed techniques, an exemplary system can be constructed for automatic advertising campaign bid optimization for achieving a maximum (or minimum) campaign bidding objective. Operations include receiving an advertising campaign specification (e.g. a data structure containing an advertising campaign specification), the advertising campaign specification specifying or containing a keyword template (e.g. a dataset of keyword templates 413₀) and collecting various historical keyword click data from a historical dataset (e.g. where the historical keyword click data is extracted corresponding to at least one keyword found in the keyword template). Once sufficient inputs have been assembled, then the system operates to formulate a linear programming optimization problem for calculating a bid amount for a particular display position. The linear programming optimization problem uses several inputs: (1) a historical cost of a click for a keyword, (2) a forecast of clicks for the keyword, (3) one or more constraints or policies, and (4) an objective function.

When an optimized bid has been calculated (e.g. by solving the linear programming optimization problem), an automated system may commence bidding for an internet search advertising impression position, possibly using an auction server.

In some cases, the advertising campaign specification comprises an advertiser business type. Similarly, in some cases, the keyword template comprises keywords selected by an advertising agency. Also, in some cases, likelihood of overbidding is mitigated by using historical keyword click data retrieved from a dataset of forecasted supply, and the forecasted supply formulated in a linear programming model constraint. Indeed, various policies may be included in the linear programming optimization problem by formulating a policy into the mathematical form of a linear inequality.

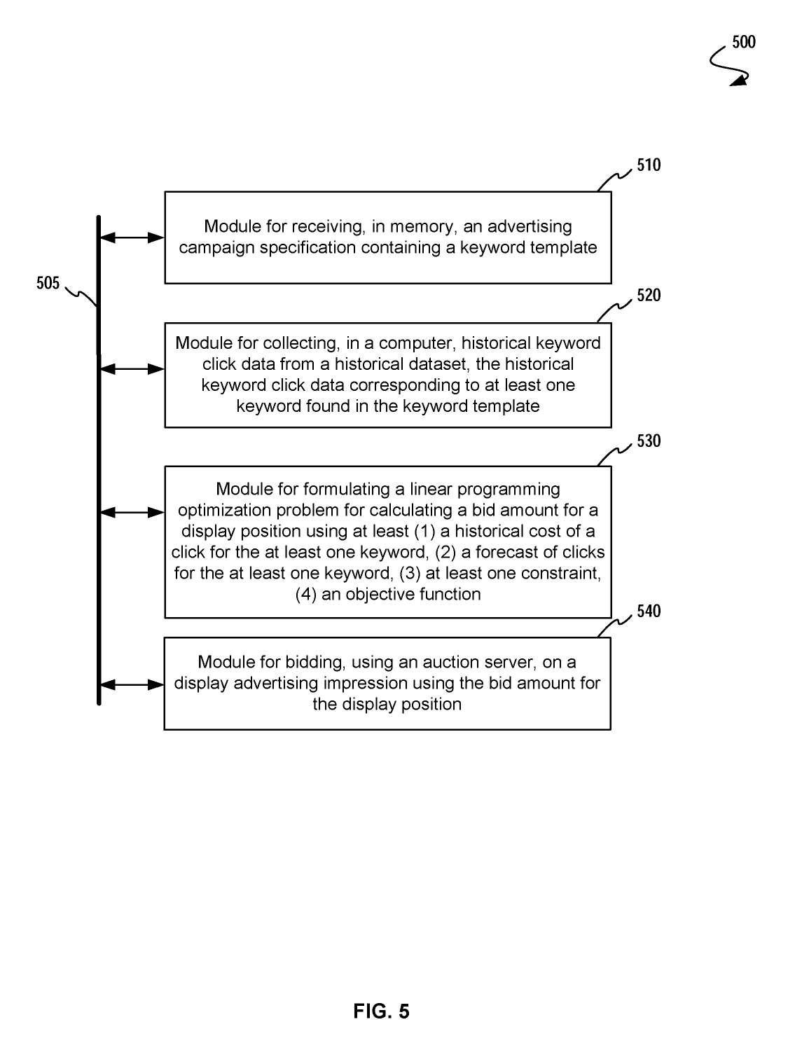

FIG. 5 depicts a block diagram of a system for automatic internet search advertising campaign variable optimization. As an option, the present system 500 may be implemented in the context of the architecture and functionality of the embodiments described herein. Of course, however, the system 500 or any operation therein may be carried out in any desired environment. As shown, system 500 includes a plurality of modules, each connected to a communication link 505, and any module can communicate with other modules over communication link 505. The modules of the system can, individually or in combination, perform method steps within system 500. Any method steps performed within system 500 may be performed in any order unless as may be specified in the claims. As shown, system 500 implements a method for automatic advertising campaign variable optimization, the system 500 comprising modules for: receiving, in memory, an advertising campaign specification containing a keyword template (see module 510); collecting, in a computer, historical keyword click data from a historical dataset, the historical keyword click data corresponding to at least one keyword found in the keyword template (see module 520); formulating a linear programming optimization problem for calculating a bid amount for a display position using at least (1) a historical cost of a click for the at least one keyword, (2) a forecast of clicks for the at least one keyword, (3) at least one constraint, (4) an objective function (see module 530); and bidding, using an auction server, on an advertising impression using the bid amount for the display position (see module 540).

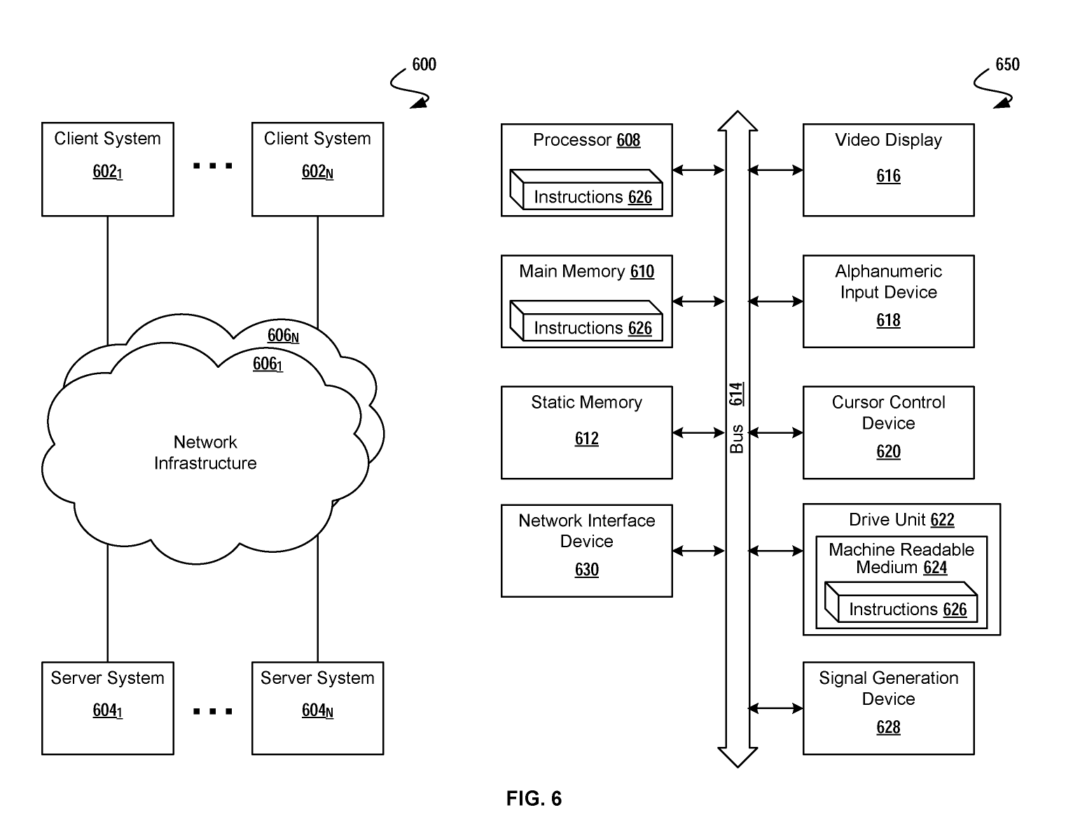

FIG. 6 is a diagrammatic representation of a network 600, including nodes for client computer systems 602₁ through 602_{N}, nodes for server computer systems 604₁ through 604_{N}, and nodes for network infrastructure 606₁ through 606_{N}, any of which nodes may comprise a machine (e.g. computer 650) within which a set of instructions for causing the machine to perform any one of the techniques discussed above may be executed. The embodiment shown is purely exemplary, and might be implemented in the context of one or more of the figures herein.

Any node of the network 600 may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system (e.g. computer 650) includes a processor 608 (e.g. a processor core, a microprocessor, a computing device, etc), a main memory (e.g. computer memory 610), and a static memory 612, which communicate with each other via a bus 614. The computer 650 may further include a display unit (e.g. computer display 616) that may comprise a touch-screen, or a liquid crystal display (LCD), or a light emitting diode (LED) display, or a cathode ray tube (CRT). As shown, the computer system also includes a human input/output (I/O) device 618 (e.g. a keyboard, an alphanumeric keypad, etc), a pointing device 620 (e.g. a mouse, a touch screen, etc), a drive unit 622 (e.g. a disk drive unit, a CD/DVD drive, a tangible computer readable removable media drive, an SSD storage device, etc), a signal generation device 628 (e.g. a speaker, an audio output, etc), and a network interface device 630 (e.g. an Ethernet interface, a wired network interface, a wireless network interface, a propagated signal interface, etc).The drive unit 622 includes a machine-readable medium 624 on which is stored a set of instructions (i.e. software, firmware, middleware, etc) 626 embodying any one, or all, of the methodologies described above. The set of instructions 626 is also shown to reside, completely or at least partially, within the main memory and/or within the processor 608. The set of instructions 626 may further be transmitted or received via the network interface device 630 over the network bus 614.

It is to be understood that embodiments of this invention may be used as, or to support, a set of instructions executed upon some form of processing core (such as the CPU of a computer) or otherwise implemented or realized upon or within a machine- or computer readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for automatic internet advertising campaign variable optimization, the method comprising:
receiving, in memory, an advertising campaign specification containing a keyword template;
collecting, in a computer, historical keyword click data from a historical dataset, said historical keyword click data corresponding to at least one keyword found in the keyword template;
calculating, in a computer, a bid amount for a display position using at least (1) a historical cost of a click for the at least one keyword, (2) a forecast of clicks for the at least one keyword, (3) at least one constraint, (4) an objective function using a linear programming optimization technique; and
bidding, using an auction server, on an advertising impression using the bid amount for the display position.

2. The method of claim 1, wherein the advertising campaign specification comprises an advertiser business type.

3. The method of claim 1, wherein the keyword template comprises keywords selected by an advertising agency.

4. The method of claim 1, wherein the historical keyword click data comprises forecasted keyword click data.

5. The method of claim 1, wherein the historical keyword click data comprises a dataset of forecasted supply.

6. The method of claim 1, wherein formulating a linear programming optimization problem comprises an objection function of the form
min ΣΣΣxᵢⱼₖ_{ⱼ}cⱼₖ_{ⱼ}.

7. The method of claim 1, wherein formulating a linear programming optimization problem comprises a minimum placement policy of the form
∀i, ΣΣxᵢⱼₖ_{ⱼ}pⱼₖ_{ⱼ}≧tᵢ.

8. The method of claim 1, wherein formulating a linear programming optimization problem comprises a position policy of the form
∀i,j Σxᵢⱼₖ_{ⱼ}≦1.

9. A computer readable medium comprising a set of instructions which, when executed by a computer, cause the computer to perform automatic internet advertising campaign variable optimization, said instructions for:
receiving an advertising campaign specification containing a keyword template;
collecting historical keyword click data from a historical dataset, said historical keyword click data corresponding to at least one keyword found in the keyword template;
calculating, in a computer, a bid amount for a display position using at least (1) a historical cost of a click for the at least one keyword, (2) a forecast of clicks for the at least one keyword, (3) at least one constraint, (4) an objective function using a linear programming optimization technique; and
bidding on an advertising impression using the bid amount for the display position.

10. The computer readable medium of claim 9, wherein the advertising campaign specification comprises an advertiser business type.

11. The computer readable medium of claim 9, wherein the keyword template comprises keywords selected by an advertising agency.

12. The computer readable medium of claim 9, wherein the historical keyword click data comprises forecasted keyword click data.

13. The computer readable medium of claim 9, wherein the historical keyword click data comprises a dataset of forecasted supply.

14. The computer readable medium of claim 9, wherein formulating a linear programming optimization problem comprises an objection function of the form
min ΣΣΣxᵢⱼₖ_{ⱼ}cⱼₖ_{ⱼ}.

15. The computer readable medium of claim 9, wherein formulating a linear programming optimization problem comprises a minimum placement policy of the form
∀i, ΣΣxᵢⱼₖ_{ⱼ}pⱼₖ_{ⱼ}≧tᵢ.

16. The computer readable medium of claim 9, wherein formulating a linear programming optimization problem comprises a position policy of the form
∀i,j Σxᵢⱼₖ_{ⱼ}≦1.

17. An advertising server network for automatic internet advertising campaign variable optimization, comprising:
a module for receiving, in memory, an advertising campaign specification containing a keyword template;
a module for collecting, in a computer, historical keyword click data from a historical dataset, said historical keyword click data corresponding to at least one keyword found in the keyword template;
a module for calculating, in a computer, a bid amount for a display position using at least (1) a historical cost of a click for the at least one keyword, (2) a forecast of clicks for the at least one keyword, (3) at least one constraint, (4) an objective function using a linear programming optimization technique; and
a module for bidding, using an auction server, on an advertising impression using the bid amount for the display position.

18. The advertising server network of claim 17, wherein formulating a linear programming optimization problem comprises an objection function of the form
min ΣΣΣxᵢⱼₖ_{ⱼ}cⱼₖ_{ⱼ}.

19. The advertising server network of claim 17, wherein formulating a linear programming optimization problem comprises a minimum placement policy of the form
∀i, ΣΣxᵢⱼₖ_{ⱼ}pⱼₖ_{ⱼ}≧tᵢ.

20. The advertising server network of claim 17, wherein formulating a linear programming optimization problem comprises a position policy of the form
∀i,j Σxᵢⱼₖ_{ⱼ}≦1.
